(19) United States
(12) Patent Application Publication
(10) Pub. No.: US 2009/0060819 A1
(43) Pub. Date: Mar. 5, 2009

(54) PROCESS FOR PRODUCING TRICHLOROSILANE

(76) Inventors: Jon M. Bill, JR., Howe, IN (US); Carl W. Merkh, Sturgis, MI (US)

Correspondence Address: TAYLOR & AUST, P.C., P.O. Box 560, 142. S Main Street, Avilla, IN, 46710, US

(21) Appl. No.: 12/200,115

(22) Filed: Aug. 28, 2008

Related U.S. Application Data
(60) Provisional application No. 60/968,703, filed on Aug. 29, 2007.

(51) Int. Cl. C01B 33/107

(52) U.S. Cl. 423/342

(57) ABSTRACT

A process for preparing high purity trichlorosilane (TCS) utilizing contaminated by-products of primary reaction products hydrogen chloride, metallurgical or chemical grade silicon stock, and/or by-products of the improved Siemens process, including “dirty” TCS containing low boiling impurities such as dichlorosilane (DCS) and “dirty” STC containing high boiling impurities. The “dirty” STC is first purified and a portion is reacted with “dirty” TCS containing DCS to produce additional TCS feedstock for the TCS purification process. Another portion of the purified STC is hydrogenated and converted back to TCS providing another feedstock to the TCS purification process. Overall net yield of high purity TCS produced is increased over established practice.

### CROSS REFERENCE TO RELATED APPLICATIONS

This is a non-provisional application based upon U.S. provisional patent application Ser. No. 60/968,703, entitled “Process for Producing Trichlorosilane”, filed Aug. 29, 2007, which is incorporated herein by reference.

### MICROFICHE APPENDIX

Not applicable.

### GOVERNMENT RIGHTS IN PATENT

Not applicable.

### BACKGROUND OF THE INVENTION

1. Field of the Invention

The present invention relates to processes for preparing trichlorosilane, and, more particularly, to a process for preparing high purity trichlorosilane from by-products of a primary reaction utilizing metallurgical or chemical-grade silicon stock, by-products of the Improved Siemens Process, or a combination thereof.

2. Description of the Related Art

The present invention relates to the field of preparing high purity trichlorosilane (abbreviated as TCS, formula HSiCl₃) for use in multiple industries.

TCS is a valuable intermediate product used to produce various silanes, for electronics and adhesives. TCS, especially the high purity grade, is used in the electronics industry including, for example, use in the preparation of solar and electronics grade polycrystalline silicon, which produces silicon tetrachloride as a by-product.

The process of preparing high purity TCS is known from many patents, including, for example, U.S. Pat. Nos. 4,112,057; 3,540,861; and 3,252,752.

The use of alkaline solids as an aid in purification of TCS is known from, for example, U.S. Pat. No. 6,843,972.

Powdered copper catalysts have been used in industry for similar reactions for some time. The use of powdered copper or mixtures of copper metal, metal halides and bromides or iodides of iron, aluminum or vanadium is reported to react silicon with silicon tetrachloride, hydrogen and, if necessary, hydrogen chloride. See, for example, Chemical Abstracts CA 101, no. 9576d, 1984 and Chemical Abstracts CA 109, no. 57621b, 1988.

It is known to those of ordinary skill in the art that trichlorosilane is usually produced in a fluidized bed. There is a disadvantage to using a fluidized bed using copper catalysts and/or catalyst mixtures containing copper; however, as the selectivity for the overall reaction, 3HCl+Si→HSiCl₃+H₂, happens in many steps and other potentially undesired by-products are produced. These by-products may include dichlorosilane (abbreviated DCS, formula H₂SiCl₂) and silicon tetrachloride (abbreviated STC, formula SiCl₄).

Since the raw material used in these reactions is often metallurgical or chemical grade silicon, other impurities are often present, such as, for example, carbon, boron, and phosphorus containing compounds.

A reactor for producing TCS, in addition to producing DCS and STC as by-products, also produces a variety of other impurities such as, for example, BCl₃, PCl₃, Iso-pentane, methyl trichlorosilane, and various other combinations of chlorine, oxygen, silane, methyl, chlorinated silane, and chlorinated methyl groups.

An exit stream from the reactor for producing TCS from metallurgical grade silicon and hydrogen chloride is defined as “raw” TCS. This stream, along with TCS, also contains DCS, STC, hydrogen, and a variety of impurities is often purified in a couple of steps to separate “raw” TCS, from “dirty” TCS and STC which are processed in waste streams and the “raw” TCS afterwards is sent on to further purification. This often yields only about 30% to 90% “raw” TCS (as a percentage of silicon molecules entering the reactor leaving in the “raw” TCS stream).

“Dirty” TCS is the name given to a by-product stream having mostly TCS and various other low boiling point compounds that may be present, including DCS.

“Dirty” STC is the name given to a by-product stream containing mostly STC and various other high boiling point compounds.

In many installations, these “dirty” by-product streams are either treated as waste or are used to produce compounds of lower value than TCS.

What is needed in the art is a method for efficiently purifying and re-converting these compounds back to trichlorosilane and to increase the overall yield of the process to produce trichlorosilane from the reaction of metallurgical silicon with hydrogen chloride.

### SUMMARY OF THE INVENTION

Exemplary embodiments of the present invention provide a means for reacting some portion of by-product streams containing STC and DCS with each other to produce more TCS after “dirty” STC has first been purified. “Dirty” STC is purified, but not limited to, using methods of distillation and adsorption to remove high boiling point reaction by-products to produce purified STC defined as “HP” STC known as “high purity” STC. Then the process simulates previous art in that the “HP” STC is hydrogenated back to TCS, also producing hydrogen chloride. The TCS thus produced is reintroduced to the “raw” TCS stream from the initial separation, and is further purified to electronics grade. The hydrogen chloride is reintroduced to the reactor utilizing the metallurgical or chemical grade silicon as a raw material.

The various exemplary embodiments herein drastically reduce kilograms of waste that are produced per kilogram of TCS. Thus, the various exemplary embodiments herein reduce the overall requirement for use of chlorine, and the amount of chlorine exiting the process in the waste streams is calculated on a mass basis to be less than about 25% of that in the waste streams of traditional prior art methods.

Other features and advantages of the invention will become apparent to those skilled in the art upon review of the following detailed description, claims and drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a flow diagram of a process known as the “Improved Siemens Process” that is used for producing trichlorosilane. The process modifications of the present invention can be used in the “Improved Siemens Process” shown in FIG. 1.

FIG. 2 is a flow diagram showing the modification in accordance with the present invention applied to the process shown in FIG. 1, for producing trichlorosilane at higher net yield efficiency.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE INVENTION

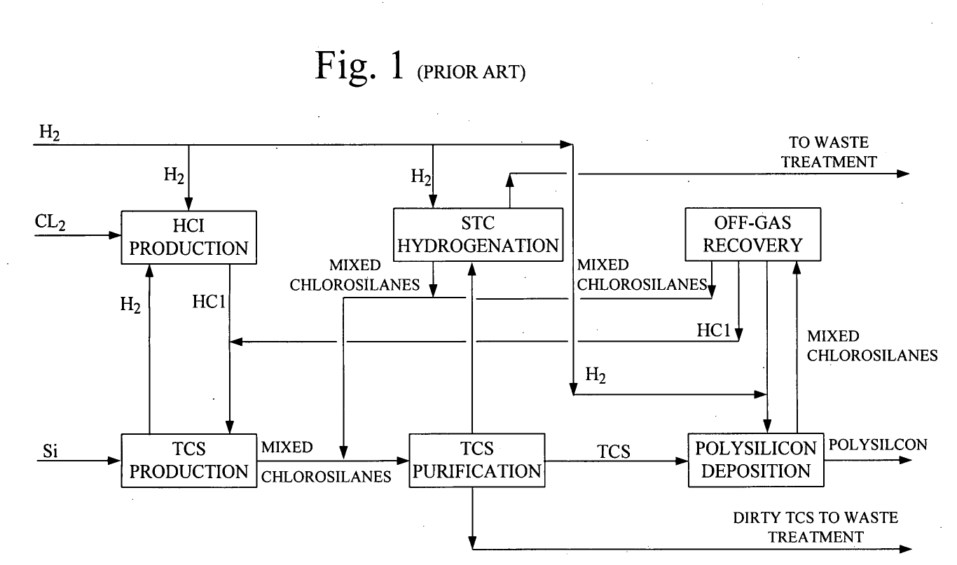

The process of the present invention begins with “dirty” TCS being produced as a by-product from any number of existing purification methods such as, for example, a distillation scheme. For example, the “Improved Siemens Process” shown in FIG. 1 is one such process for which the present invention can be used. However, it is expected that other processes also can benefit from the application of modifications in accordance with the present invention.

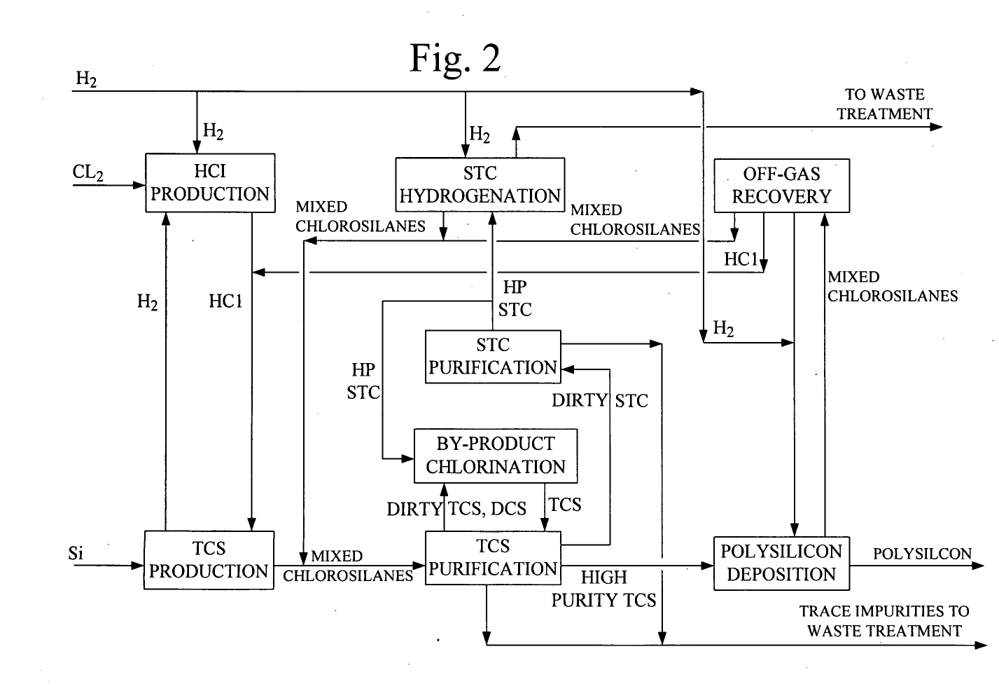

Contaminated by-products from the “TCS Purification” stage include both “dirty” TCS and “dirty” STC. As shown in FIG. 2, in a “By-Product Chlorination” stage, the “dirty” TCS containing dichlorosilane (abbreviated DCS, formula H₂SiCl₂) is reacted with purified STC known as “HP” STC to produce TCS. The new TCS product produced is recycled back to the TCS purification stage. The selection of a reactor for the reaction according to the invention is not believed to be critical. A typical example is the introduction of the “dirty” TCS″ containing DCS into the bottom or top of a stirred tank filled with STC and catalyst.

The reaction can take place at temperatures between about 4° C. to about 70° C., depending on the temperature stability of the catalyst in use.

The mole ratio of silicon tetrachloride molecules in the feed stock to dichlorosilane molecules in the reaction according to the invention can be for example about 1:4 to about 5:1. A mole ratio of about 2:1 to about 5:1 is preferred.

In a stage designated in FIG. 2 as “STC Purification,” the silicon tetrachloride separated from the “dirty” TCS in the TCS purification stage, known as “dirty” STC, is separated from higher boiling impurities by a suitable separation process, such as, for example, distillation. The purified STC obtained is then converted to TCS in accordance with known steps of the “Improved Siemens Process” such as, for example, STC hydrogenation. A portion of this purified STC, also called “HP” STC, is used in the chlorination reaction with DCS for conversion to TCS also.

The separation of TCS reactor by-products in the TCS Purification stage can include a reflux ratio of one to two hundred for the separation by distillation of “dirty” TCS from “raw” TCS. The purification of “raw” TCS can include pressure and temperature swing adsorption. The separation of STC hydrogenation reactor products can include the distillation of TCS from STC prior to mixing with unpurified TCS streams. “Dirty” TCS containing DCS can be reacted with “HP” STC, chlorine, and/or hydrogen chloride in a liquid phase reactor. Preferably “dirty” TCS containing DCS is reacted using only purified STC, known as “HP” STC, in a liquid and/or vapor phase reactor in presence of a suitable catalyst to produce TCS for additional feedstock to the TCS purification process.

The high purity trichlorosilane produced by the various exemplary embodiments of the present invention can be used, for example, for the manufacture of silane, and/or directly for solar-grade or electronics grade poly-silicon crystals. Therefore the invention also relates to a method for producing silane and/or poly-silicon crystals on the basis of high purity trichlorosilane obtained according to the above exemplary embodiments.

Preferably, the various exemplary embodiments herein are integrated into a general method for manufacture of solar or electronics grade poly-silicon crystals.

In a preferred embodiment, an exemplary embodiments of the present invention can be integrated into a multistage general method for producing poly-silicon crystals, as specified, for example, in “Economics of Polysilicon Process, Osaka Titanium Co., DOE/JPL 1012122 (1985), 57-78” and comprising the steps of: producing TCS; disproportioning TCS to yield silane; purifying silane to obtain high-purity silane; and thermally decomposing silane in a fluidized-bed reactor and depositing hyper-pure silicon on the silicon particles which form the fluidized bed.

In another preferred embodiment, an exemplary embodiments of the present invention may be integrated into a method for producing silane and/or solar or electronics grade poly-silicon crystals comprising the steps of: synthesizing and isolating TCS via distillation from “raw” TCS, and recycling “dirty” TCS and silicon tetrachloride; additional purifying of the “raw” TCS by purification techniques, including, but not limited to, distillation and/or adsorption; additional purifying of silicon tetrachloride to remove high boiling impurities by purification techniques, including, but not limited to, distillation and/or adsorption; hydrogenating purified STC to produce additional TCS feed to the TCS purification process; chlorinating DCS by-product by reaction with purified STC to produce additional TCS feed to the TCS purification process; disproportioning high purity TCS to silane or poly-silicon crystals utilizing an deposition technique, including, but not limited to, a Siemens reactor.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A process for preparing high purity trichlorosilane (TCS) utilizing contaminated by-products of an improved Siemens process, the process being comprised of the steps of:
synthesizing “raw” TCS via reaction of metallurgical grade or chemical grade silicon with hydrogen chloride to, wherein the “raw TCS is a primary feedstock to a TCS purification process;
purifying the “raw” TCS to separate out “dirty” TCS having low-boiling impurities and dichlorosilane (DCS) and “dirty” silicon tetrachloride (STC) containing high-boiling impurities;
purifying STC from the “dirty” STC;
hydrogenating the purified STC to produce additional “raw” TCS feed to the TCS purification; and
reacting the “dirty” TCS with purified STC in the presence of a catalyst to produce TCS which is recycled as additional TCS feedstock back to the TCS purification process.

2. The process according to claim 1, wherein the high purity TCS is used for or with a chemical vapor deposition process to produce semi-conductor grade or solar grade polysilicon crystal, to produce other silanes, to produce adhesives, to produce electronic specialty material components, or a combination thereof.

3. The process according to claim 1, wherein the high purity TCS is used for production of high purity silane (SiH₄) that can be used to produce silanes, adhesives, and electronics such as chemical vapor deposition of semiconductor grade or solar grade polysilicon crystal.

4. The process according to claim 1, the steps of purifying may be accomplished via one or more of distillation or adsorption.

5. The process according to claim 1, wherein the hydrogenating includes a reflux ratio of 1 to 200 for separation by distillation of “dirty” TCS from “raw” TCS.

6. The process according to claim 1, wherein the purifying of “raw” TCS includes pressure and temperature swing adsorption.

7. The process according to claim 1, wherein the hydrogenating includes distillation of TCS from STC prior to mixing with other unpurified TCS streams.

8. The process according to claim 1, wherein the “dirty” TCS having DCS is reacted with purified STC in a liquid and/or vapor phase reactor in presence of a suitable catalyst.

9. The process according to claim 8, wherein the process takes place at temperatures from about 4 to about 70 degrees C.

10. The process according to claim 8, wherein in the reacting the “dirty” TCS with purified STC, a mole ratio of STC molecules to DCS molecules is from about 1:4 to about 5:1.

11. The process according to claim 8, wherein in the reacting the “dirty” TCS with purified STC, a mole ratio of STC molecules to DCS molecules is from about 2:1 to about 5:1.

12. The process according to claim 1, wherein the TCS is used to prepare solar grade or electronics semiconductor grade polycrystalline silicon.
